(19) United States
(12) Patent Application Publication
(10) Pub. No.: US 2007/0100076 A1
(43) Pub. Date: May 3, 2007

(54) High modulus ionomers for packaging

(76) Inventors: Richard Allen Hayes, Brentwood, TN (US); Barry Alan Morris, Wilmington, DE (US); Matthew Scott Hall, Beaumont, TX (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/261,195

(22) Filed: Oct. 28, 2005

(51) Int. Cl. C08L 77/00; C08F 8/00

(52) U.S. Cl. 525/178; 525/191

(57) ABSTRACT

A multilayer packaging film or sheet is disclosed. The film comprises at least one layer comprising or produced from an olefin copolymer, a composition, or combinations thereof in which the composition comprises the olefin copolymer and a polyamide, a barrier resin, a polyolefin, a vinyl ester copolymer, a carboxylate ester copolymer, or combinations of two or more thereof and the olefin copolymer is a magnesium-neutralized ionomer and comprises repeat units derived from an α-olefin and a comonomer including one or more α-, β-ethylenically unsaturated carboxylic acids. Further disclosed is a shaped article comprising or produced from the packaging film or sheet and packaged food.

The invention relates to a multilayer packaging film or sheet comprising at least one layer of magnesium ion-neutralized copolymers of α-olefins and α-, β-ethylenically unsaturated carboxylic acids, to a process therefor, to a process therewith, and to an article produced therefrom including packaged foods contained therein.

### BACKGROUND OF THE INVENTION

Ionomeric materials have long been established within the packaging industry due to their excellent heat sealability and adhesive properties. Representative of the background, the ionomers exemplify sodium- or zinc-neutralized ethylene-co-(meth)acrylic acid ionomers. See, e.g., U.S. Pat. Nos. 3,264,272, 3,338,739, 3,355,319, 3,404,134, 4,188,441, 4,239,826, 4,335,175, 4,389,450, 4,606,922, 4,656,068, 4,888,223, 4,916,025, 4,925,318, 4,934,544, 5,185,189, 5,425,974, 5,445,893, 5,679,422, 5,827,559, 5,840,422, 5,882,749, 5,882,789, 5,895,587, 5,972,447, 5,981,047, 6,110,600, 6,221,410, 6,764,729, 6,358,622, 6,428,648, 6,476,137, 6,517,920, 6,541,087, 6,630,237, and 6,682,825. See also EP 432 611, US2002/0090472, US2003/0044551, WO 02/078885, US 2005/0112247, EP 1 555 120, and WO 2004/068951.

Magnesium-neutralized ionomers have also been known. See, e.g., U.S. Pat. Nos. 3,264,272, 3,264,272, 4,984,804, 5,244,969, 5,321,089, 5,542,677, 5,591,803, 6,100,321, 6,100,336, 6,100,340, 6,197,884, 6,207,760, 6,267,693, 6,562,906, 6,613,843, 6,653,382, 6,762,246, 6,777,472, and 6,815,480. See also, WO 98/47957 and WO 00/73384.

U.S. Pat. Nos. 4,666,988, 4,774,290 and 4,847,164, disclose a process for producing magnesium-neutralized ethylene/olefinically-unsaturated carboxylic acid copolymers with the use of certain magnesium oxide dispersions in ethylene copolymers of LDPE (low density polyethylene), HDPE (high density polyethylene), or LLDPE (linear low density polyethylene) such that they allow for up to about 5.7 weight % of ethylene copolymer in the final product.

Certain magnesium-neutralized ionomers have been utilized within food packaging enduses. The vinyl alkanoate or unsaturated alkyl ester monomeric component is present in a terpolymer to provide a component for increasing adhesion to film, foil, and paper substrates and to provide increased flexibility to the composition and to broaden the effective heat sealing temperature range. At high acid contents, the terpolymer exhibits undesirably high modulus. See, e.g., U.S. Pat. Nos. 4,346,196 and 4,469,754. Heat sealable blends of an ionomer with propylene copolymers were also disclosed (U.S. Pat. Nos. 4,539,263 and 4,550,141). The ionomer was neutralized with magnesium ions and propylene copolymer added up to a level of 20 %.

The art discloses against neutralization levels of 90% or less and prefers neutralization levels of 100% (by adding more metal ions than that required for 100% neutralization). See e.g., US 2003/0198715 and WO 03/089240.

It appears that the magnesium-neutralized ionomers having been utilized within food packaging require high levels of a softening comonomer, high levels of a soft, acid-containing blend polymer, such as ethylene-co-isobutyl acrylate-co-methacrylic acid terpolymer, high levels of a fatty acid, or combinations thereof. These high levels may lead to a reduction in the obtainable physical properties, such as the flexural modulus, which, in turn, reduces desirable packaging attributes, such as stiffness and rigidity, in the final packaging product. Therefore, it is desirable to overcome such shortcomings and to provide packaging materials with processability, resistance to enduse stresses, stiffness, and rigidity.

### SUMMARY OF THE INVENTION

The invention includes a composition or blend comprising or produced from an olefin copolymer and a polyamide, a barrier resin, a polyolefin, a vinyl ester copolymer comprising repeat units derived from an α-olefin and a vinyl ester, or combinations of two or more thereof wherein the olefin copolymer is magnesium ion-neutralized; comprises repeat units derived from an α-olefin and a comonomer including one or more α-, β-ethylenically unsaturated carboxylic acids; and can contain from about 1 to about 30, or about 7 to about 30, or about 18 to about 25, weight % of the comonomer based on the total weight of the copolymer.

The invention also includes a film or sheet, preferably a packaging film, sheet, or both comprising at least one layer of an olefin copolymer, a composition or blend, or combinations thereof wherein the olefin copolymer can be the same as disclosed above, the composition comprises the olefin copolymer and a polyamide, a barrier resin, a polyolefin, a vinyl ester copolymer comprising repeat units derived from an α-olefin and a vinyl ester, a carboxylate ester copolymer comprising repeat units derived from an α-olefin and a carboxylate ester, or combinations of two or more thereof, and the film or sheet can have enhanced physical properties including higher flexural moduli and stiffness and the comonomer includes acrylic acid, methacrylic acid, or combinations thereof.

The invention also preferably includes a multilayer film or sheet, preferably a multilayer packaging film, sheet, or both comprising at least one layer of an olefin copolymer, the composition or blend, or combinations thereof wherein the olefin copolymer and composition can be the same as disclosed immediately above.

The composition or blend can comprise from optionally about 1 to about 99, about 50 to about 99, or about 80 to about 98, weight % of polyamide; optionally from about 1 to about 99, about 60 to about 99, about 70 to about 97, or about 80 to about 95, weight % of barrier resin; optionally from about 1 to about 99, about 10 to about 50, about 10 to about 30, or about 10 to about 25, weight % of the polyolefin; optionally from about 1 to about 99, about 1 to about 50, about 1 to about 30, or about 5 to about 25 weight % of the vinyl ester copolymer; and/or optionally from about 1 to about 99, about 1 to about 30, or about 5 to about 25 weight % of the carboxylate ester copolymer; and optionally combinations of two or more thereof, all based on the total weight of the composition. The composition of the invention can provide improved processability, such as through, for example, thermoforming operations, to provide packaging films and multilayer films with enhanced resistance to commonly encountered enduse conditions, such as the use of flavorants, such as liquid smoke, and oil and fat penetration resistance.

The invention further includes a shaped article comprising or produced from the blend or composition or the packaging film or sheet.

### DETAILED DESCRIPTION OF THE INVENTION

The application frequently discloses composition or process for making “film”. Such composition and process can be used for “sheet”.

The α-olefin of the olefin copolymer can be ethylene, propylene, 1-butene, 1-pentene, 1-hexene, 1-heptene, 3-methyl-1-butene, 4-methyl-1-pentene, or combinations or two or more thereof. Frequently used α-olefin is ethylene.

The comonomer can be an α-, β-ethylenically unsaturated carboxylic acid including one or more (meth)acrylic acids such as methacrylic acid, acrylic acid, itaconic acid, maleic acid, maleic anhydride, fumaric acid, monoalkyl ester of maleic acid such as monomethyl maleic acid, or combinations of two or more thereof.

For examples, magnesium-neutralized olefin copolymers can include magnesium-neutralized ethylene copolymer comprising repeat units derived from ethylene and one or more comonomers disclosed above. Examples include magnesium-neutralized, ethylene acrylic acid copolymer, ethylene methacrylic acid copolymer, or combinations thereof. The copolymers can be neutralized with magnesium ions at a level from about 5% to about 90, about 10% to about 75, or from about 20% to about 60, %.

The magnesium-neutralized copolymers may contain from about 1 to about 30, about 9 to about 30, or about 18 to about 25, weight % of the comonomer based on the total weight of the copolymer based on even greater enhanced physical properties, such as higher flexural moduli and stiffness.

The ethylene copolymers can be produced by any methods known to one skilled in the art such as those disclosed in, for example, U.S. Pat. Nos. 3,264,272, 3,355,319, 3,404,134, 3,520,861, 4,248,990, 5,028,674, 5,057,593, 5,827,559, 6,500,888 and 6,518,365 and can be neutralized with magnesium ions as disclosed in, for example, U.S. Pat. Nos. 3,404,134, 4,666,988, 4,774,290, and 4,847,164, the disclosures of these US patents are incorporated herein by reference. Examples of magnesium-neutralized ethylene copolymers are commercially available such as Surlyne® 6120 from the E.I. du Pont de Nemours and Company (Wilmington, Del.) (DuPont).

Polyamide (nylon) is a homopolymer or copolymer including aliphatic polyamides and aliphatic/aromatic polyamides and can have a molecular weight of from about 10,000 to about 100,000. General procedures useful for the preparation of polyamides are well known to one skilled in the art and the description of which is omitted herein for the interest of brevity.

Examples of polyamides include, but are not limited to, poly(4-aminobutyric acid) (nylon 4), poly(6-aminohexanoic acid) (nylon 6, also known as poly(caprolactam)), poly(7-aminoheptanoic acid) (nylon 7), poly(8-aminooctanoic acid)(nylon 8), poly(9-aminononanoic acid) (nylon 9), poly(10-aminodecanoic acid) (nylon 10), poly(11-aminoundecanoic acid) (nylon 11), poly(12-aminododecanoic acid) (nylon 12), as well as nylon 46, nylon 66 and nylon 69, poly(hexamethylene adipamide) (nylon 6,6), poly(hexamethylene sebacamide) (nylon 6,10), poly(heptamethylene pimelamide) (nylon 7,7), poly(octamethylene suberamide) (nylon 8,8), poly(hexamethylene azelamide) (nylon 6,9), poly(nonamethylene azelamide) (nylon 9,9), poly(decamethylene azelamide) (nylon 10,9), caprolactam/hexamethylene adipamide copolymer (nylon 6,6/6), hexamethylene adipamide/caprolactam copolymer (nylon 6/6,6), trimethylene adipamide/hexamethylene azelaiamide copolymer (nylon trimethyl 6,2/6,2), hexamethylene adipamide-hexamethylene-azelaiamide caprolactam copolymer (nylon 6,6/6,9/6), poly(tetramethylenediamine-co-oxalic acid) (nylon 4,2), the polyamide of n-dodecanedioic acid and hexamethylenediamine (nylon 6,12), the polyamide of dodecamethylenediamine and n-dodecanedioic acid (nylon 12,12), polyamides based on dimer acid, polyamide 6,6/6,10, polyamide 6/6,9, poly(tetramethylenediamine-co-isophthalic acid) (nylon 4,I), polyhexamethylene isophthalamide (nylon 6,I), hexamethylene adipamide/hexamethylene-isophthalamide (nylon 6,6/6I), hexamethylene adipamide/hexamethyleneterephthalamide (nylon 6,6/6T), poly (2,2,2-trimethyl hexamethylene terephthalamide), poly(m-xylylene adipamide) (MXD6), poly(p-xylylene adipamide), poly(hexamethylene terephthalamide), poly(dodecamethylene terephthalamide), polyamide 6T/6I, polyamide 6/MXDT/I, polyamide MXDI, polyamide 6,6/6,9/6I, or combinations of two or more thereof. Commercially available polyamides include Selar® PA from DuPont and MXD-Nylon® from Mitsubishi Gas Chemical Company.

Barrier resins can include polyacrylonitrile resins, polyvinylidene chloride resins, ethylene vinyl alcohol copolymers, polyalkylene carbonate resins, other high oxygen barrier resins, or combinations of two or more thereof.

Polyvinylidene chloride resin can be a copolymer comprising repeat units derived from 65 to 95 weight % vinylidene chloride and 35 to 5 weight % of at least one comonomer including vinyl chloride, acrylonitrile, an unsaturated α-, β-carboxylate ester, an α-, β-ethylenically unsaturated carboxylic acid, or combinations of two or more thereof.

Examples of polyvinylidene chloride resins include vinylidene chloride-co-vinyl chloride which incorporates from about 5 to about 25 weight % vinyl chloride, vinylidene chloride-co-methyl acrylate which incorporates from about 5 to 30 weight % methyl acrylate, or combinations thereof. The vinylidene chloride-co-methyl acrylate copolymers may not be affected by moisture, may not require adhesive layers, and may have minimal discoloration during cooking.

An example of barrier resin is ethylene vinyl alcohol copolymers (EVOH) that resists to degradation upon irradiation, allowing for the production of coextruded, totally irradiated films, which are desirable for cook-in conditions. EVOH are well known in the art and readily commercially available. EVOH can be prepared by the any known methods such as those disclosed in U.S. Pat. Nos. 3,510,464, 3,560,461, 3,847,845, 3,595,740 and 3,585,177, disclosures of which are incorporated herein by reference. EVOH can be a hydrolyzed ethylene vinyl acetate copolymer. The degree of hydrolysis can range from about 85 to about 99.5%, about 90% or higher, about 95% or higher, or about 98% or higher.

Mixtures of two or more different EVOH may be used to provide thermoformability and gas barrier properties as disclosed in, for example, U.S. Pat. No. 5,972,447.

EVOH may incorporate additional comonomers such as a vinyl silane comonomer in an amount of about 0.0002 to about 0.2 mole % to improve the compatibility of EVOH during coextrusion. Examples of the vinyl silane comonomers include vinyltrimethoxysilane, vinyltriethoxysilane, vinyltri(β-methoxyethoxy)silane, γ-methacryloxypropylmethoxysilane, or combinations of two or more thereof.

An EVOH can incorporate one or more phosphorus compounds at a level of from about 1 to about 200 ppm, about 2 to about 150 ppm, or about 5 to about 100 ppm, (in terms of element phosphorus based on the amount of the EVOH) to provide thermal stability and film forming characteristics.

An EVOH can incorporate one or more alkali metal ions such as sodium, potassium, and lithium at a level of from about 10 to about 500 ppm, (in terms of the metal element based on the amount of the ethylene vinyl alcohol copolymers), to enhance compatibility and adhesion between film layers. Examples of the alkali metal compounds include monovalent metal salts of aliphatic carboxylic acids, aromatic carboxylic acids, and phosphoric acid and metal complexes such assodium acetate, potassium acetate, sodium phosphate, lithium phosphate, sodium stearate, potassium stearate, sodium ethylenediaminetetraacetate, or combinations of two or more thereof.

EVOH are commercially available from a variety of sources such as EVAL® from Kuraray Company of Japan and Soarnol® from Nippon Gosei of Japan. Commercially-available grades have 32 to 36% ethylene, a molecular weight of 29,500 and a melting point of 356° F. (180° C.); 29% ethylene, a molecular weight of 22,000 and a melting point of 365° F. (185° C.); and 40% ethylene, a molecular weight of 26,000 and a melting point of 327° F. (164° C.).

Polyolefins include any polymerized olefin, which can be linear, branched, cyclic, aliphatic, aromatic, substituted or unsubstituted and can comprise α-olefin homopolymers and copolymers and blends thereof, where the α-olefin monomers have from about 2 to about 10 or about 2 to about 6 carbon atoms. Examples of α-olefins include ethylene, 1-butene, 1-pentene, 1-hexene, 1-octene, 3-methyl-1-butene, 4-methyl-1-butene, or combinations of two or more thereof. Ethylene/α-olefin copolymers can include from about 80 to about 99 or about 88 to about 95 weight % ethylene and from about 1 to about 20, about 5 to about 15, about 1 to about 12, about 2 to about 8, or about 3 to about 5, weight % α-olefin comonomer, based on the total weight of the copolymer. Non-limiting examples of polyolefins are polyethylene (PE), LDPE, LLDPE, linear medium density polyethylene (LMDPE), linear very-low density polyethylene (VMDPE and VLDPE), linear ultra-low density polyethylene (UMDPE and ULDPE), high density polyethylene (HDPE), ethylene/α-olefin copolymers or terpolymers, polypropylene (PP), syndiotactic polypropylene (SPP), isotactic polypropylene, propylene/ethylene copolymers, ethylene/propylene random copolymers, ethylene/propylene block copolymers, propylene/α-olefin copolymers or terpolymers, polyethylene interpolymers, i.e. copolymers of ethylene with α-olefins characterized by a narrow distribution of the molecular weights and obtained by means of polymerization with metallocene catalysts (see U.S. Pat. Nos. 4,306,041), polybutylene, poly(1-butene), butene/α-olefin copolymers or terpolymers, ethylene/propylene/butene terpolymers, 4-methyl-1-pentene polymers and copolymers, poly(pentene-1), poly(3-methylbutene-1), poly(4-methylpentene-1), and poly(hexene-1), metallocene- polyethylene, (such as m-LPE (linear polyethylene), m-LHDPE, (linear high density polyethylene), m-LLDPE (linear low density polyethylene), m-ULLDPE (ultra low linear density polyethylene), poly(propylene), poly(butylene), poly(butene-1), poly(pentene-1), poly(3-methylbutene-1), poly(4-methylpentene-1), and poly(polyhexene-1), cyclic olefin copolymers (COC), or combinations of two or more thereof such as Topas®, Versify® polypropylene copolymers, and the like and mixtures thereof.

Metallocene catalyzed polyolefins are commercially available including Exact® and Exceed® from ExxonMobile Corporation (Exxon) and Tafmere® from Mitsui Petrochemical Corporation. Commercial ethylene/α-olefin copolymers include Affinity®, Engage® and Elite® from the Dow Chemical Company.

Mixtures of two or more polyolefins may be used within the blends of the present invention. The polyolefins may be modified as through, for example, radical grafting of maleic anhydride and the like.

Examples of the vinyl ester include vinyl acetate, vinyl propionate, vinyl butyrate, or combinations of two or more thereof. Vinyl ester level can be from about 1 to about 50, about 5 to about 30 weight %, or about 5 to about 20 weight %, based on the total weight of the copolymer. Commercial ethylene vinyl acetate resins include Elvax® from DuPont, Ultrathene® from the Equistar Chemicals, LP, and Escorene® from Exxon.

The α-, β-ethylenically unsaturated carboxylate esters include methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol) methyl ether acrylate, poly(ethylene glycol) methyl ether methacrylate, poly(ethylene glycol) behenyl ether acrylate, poly(ethylene glycol) behenyl ether methacrylate, poly(ethylene glycol) 4-nonylphenyl ether acrylate, poly(ethylene glycol) 4-nonylphenyl ether methacrylate, poly(ethylene glycol) phenyl ether acrylate, poly(ethylene glycol) phenyl ether methacrylate, dimethyl maleate, diethyl maleate, dibutyl maleate, dimethyl fumarate, diethyl fumarate, dibutyl fumarate, dimenthyl fumarate, or combinations of two or more thereof.

The unsaturated carboxylate ester level can be about 5 to 75 or about 5 to 35 weight %, based on the total weight of the copolymer.

The composition or blend may be produced by any known art method. For example, the blend components may be admixed together to form a “pellet” blend which may be fed directly to the process for the formation of the shaped articles of the present invention, such as the packaging film, multilayer film, sheet or multilayer sheet. Any of the blend components may be dried as desired before, during or after the blending process.

The “pellet blend” can be melt compounded by any known high shear, intensive melt mixing process known to one skilled in the art. Such a process can involve intensive mixing of the molten blend components with other optional components. The intensive mixing may be provided through static mixers, rubber mills, Brabender mixers, Buss kneaders, Banbury mixers, pressure kneaders, single screw extruders, twin screw extruders, disc attritors, and the like. Such intensive mixing equipment is commercially available from, for example, the Farrel Company, the Coperion Company and the Toshiba Machine Company. The blend components may be dried prior to any mixing step. The blend components may then be mixed with the other optional components as a dry blend, typically referred to as a “pellet blend”, as described above. Alternatively, the blend components may be co-fed through two or more different feeders. In an extrusion process, the blend components would typically be fed into the back, feed section of the extruder. The blend components may be fed into two or more different locations of the extruder. For example, one of the blend components may be added in the back, feed section of the extruder while another blend component is fed in the front of the extruder near the die plate. The extruder temperature profile can be set up to allow the blend components to melt under the processing conditions. The screw design may provide stress and, in turn, heat, to the resins as it mixes the molten blend components. Generally, the melt processing temperature may be within the range of about 50° C. to about 300° C.

The composition or blend may include additives known in the art including one or more plasticizers, processing aides, flow enhancing additives, lubricants, pigments, dyes, flame retardants, impact modifiers, nucleating agents to increase crystallinity, antiblocking agents such as silica, thermal stabilizers, UV absorbers, UV stabilizers, dispersants, surfactants, chelating agents, coupling agents, adhesives, primers, antistatic agents, slip agents and the like. The stabilizers can protect the packaging materials from aging and the food product contained therein to, for example, harmful UV light.

Any known thermal stabilizer can be used including phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, or combinations of two or more thereof.

UV absorbers are well disclosed within the art including one or more benzotriazoles, hydroxybenzophenones, hydroxyphenyl triazines, esters of substituted and unsubstituted benzoic acids, or combinations of two or more thereof.

The composition may incorporate an effective amount of hindered amine light stabilizers (HALS). HALS includes secondary, tertiary, acetylated, N-hydrocarbyloxy substituted, hydroxy substituted N-hydrocarbyloxy substituted, or other substituted cyclic amines which further incorporate steric hindrance, generally derived from aliphatic substitution on the carbon atoms adjacent to the amine function, or combinations of two or more thereof.

Plasticizers include dimethyl phthalate, diethyl phthalate, dioctyl phthalate, wax, fluid paraffin, phosphate esters, or combinations of two or more thereof.

Antistatic agents such as pentaerithrytol monostearate, sorbitan monopalmitate, sulfated polyolefin, polyethylene oxide, carbo-wax, or combinations of two or more thereof may be incorporated within the compositions as desired.

Slip agents such as ethylene bis-stearamide, butyl stearate, or combinations of two or more thereof, may be incorporated within the compositions as desired.

The additive can be present in the composition or blend from about 0 to about 10, about 0.0001 to about 5, or about 0.001 to about 1 weight %, based on the total weight of the composition.

An antifog composition can be formed either on a surface of the film or incorporated into the film, generally the outer layer of the film. Examples of antifog compositions are glycerol monoesters of a saturated or unsaturated fatty acid having from about 8 to about 20 carbon atoms, glycerol diesters of a saturated or unsaturated fatty acid having from about 8 to about 20 carbon atoms; and anionic, cationic, nonionic and amphoteric surfactants such as phosphate, sulfate or quaternary amine functional end groups. Other antifog compositions include sorbitan esters of aliphatic carboxylic acids, glycerol esters of aliphatic carboxylic acids, esters of other polyhydric alcohols with aliphatic carboxylic acids, polyoxyethylene compounds, such as the polyoxyethylene sorbitan esters of aliphatic carboxylic acids and polyoxyethylene ethers of higher aliphatic alcohols. Antifog compositions glycerol monooleate, glycerol monostearate or blends thereof are frequently used. When the antifog composition is incorporated into a film, it can be in an amount of from about 0.1 weight % to about 5 weight %. When an antifog composition is coated on the film it can be applied at a coating weight of from about 0.2 to about 0.6 g/m². See, e.g., U.S. Pat. No. 5,766,772, incorporated herein by reference.

A film such as multilayer film or sheet can be made by any process known in the art such as formed through dipcoating as taught in U.S. Pat. No. 4,372,311, through compression molding as disclosed in U.S. Pat. No. 4,427,614, through melt extrusion as disclosed in U.S. Pat. No. 4,880,592, through melt blowing as disclosed in U.S. Pat. No. 5,525,281, or other art processes, the disclosure of these patents are incorporated herein by reference.

A multilayer film can have any total thickness desired to provide the desired properties for the particular packaging operation such as a total thickness (a combined thickness of all layers) of about 15 mils, (0.38 millimeters (mm)), or less or from about 0.3 to about 15 mils, about 1 to about 10 mils, or 1.5 to 8 mils.

For example, a multilayer film can be produced by coextrusion. Orientation (either uniaxially or biaxially) can be effected by various methodologies (e.g., blown film, mechanical stretching or the like).

Coextrusion can be carried out according to any known coextrusion methods. For example, a film can be manufactured by extrusion using so-called “blown film” or “flat die” methods. A blown film, which is generally stronger and tougher than cast film, can be prepared by extruding a tube or coextruding polymer compositions through an annular die such that a seamless, tubular multilayer film having concentric layers of the compositions is prepared. Expanding the resulting tubular film with an air current provides a blown film. Cast flat films are prepared by coextruding the individual compositions through a flat die to provide a laminar flow of the layered compositions. The molten laminar flow leaving the die is cooled by at least one roll containing internally circulating fluid (a chill roll) or by a water bath to provide a cast film. The film can be sized by conventional techniques such as slitting to provide a packaging film. A film disclosed may have a width of about 25 to 60 cm (about one to two feet).

Multilayer films may also be produced as bilayer, trilayer, or multilayer structures. Multilayer structures may be formed through coextrusion, blown film, dipcoating, solution coating, blade, puddle, air-knife, printing, Dahlgren, gravure, powder coating, spraying, or other art processes. Generally, the multilayer films are produced through extrusion casting, blown film, adhesive lamination or extrusion lamination processes. For example, polymer compositions are heated in a uniform manner followed by being conveyed to a coextrusion adapter that combines the molten materials to form a multilayer coextuded structure. The layered polymeric material is transferred through an extrusion die opened to a predetermined gap, commonly in the range of between about 0.13 cm and about 0.03 cm. The material is then drawn down, with draw down ratios ranging from about 5:1 to about 40:1, to the intended gauge thickness by means of a primary chill or casting roll maintained at typically in the range of about 15 to about 55° C. The additional layers may serve as barrier layers, adhesive layers, antiblocking layers, or for other purposes. Similar processes may be adapted for blown film processes.

Production of multilayer films or sheets by extrusion, co-extrusion, lamination, or lamination/coating process is well known to one skilled in the art (see, e.g., US 4,677,017, US 5,055,355, US 5,139,878, and US 6,903,161), the disclosures of which are incorporated herein by reference.

A film disclosed here can be further oriented beyond the immediate quenching or casting of the film, by extruding a laminar flow of molten polymer to produce an extrudate, quenching the extrudate and orienting the quenched extrudate in at least one or more directions.

The film can be unoriented, oriented in a uniaxial direction (e.g. machine direction), or oriented in a biaxial direction (e.g. machine direction and transverse direction). The film may be biaxially oriented by drawing in two mutually perpendicular directions in the plane of the film to achieve a satisfactory combination of mechanical and physical properties.

Orientation and stretching apparatus to uniaxially or biaxially stretch film are known in the art and may be adapted by those skilled in the art to produce films of the present invention. See, e.g., apparatus and processes disclosed in U.S. Pat. Nos. 3,278,663; 3,337,665; 3,456,044; 4,590,106; 4,760,116; 4,769,421; 4,797,235 and 4,886,634.

For example, a blown film may be oriented using a double bubble extrusion process, where simultaneous biaxial orientation may be effected by extruding a primary tube which is subsequently quenched, reheated and then expanded by internal gas pressure to induce transverse orientation, and drawn by differential speed nip or conveying rollers at a rate which will induce longitudinal orientation.

An oriented blown film may be made by any methods known in the art such as disclosed in U.S. Pat. No. 3,456,044, the disclosure of which is incorporated herein by reference and is omitted for the interest of brevity.

The multilayer film may be oriented and then heat set or annealed. The multilayer film can have a transverse direction free shrink of about 0 to 20% at 185° F. or about 2 to 10%.

For example, a film can be drawn to a draw ratio of from 1.5:1 to 5:1 uniaxially in at least one direction (its longitudinal direction), its transverse direction or biaxially in each of its longitudinal and transverse directions by passing it over a series of preheating and heating rolls. The heated film moves through a set of nip rolls downstream at a faster rate than the film entering the nip rolls at an upstream location.

For manufacturing large quantities of film, a sheeting calender may be employed. The rough film is fed into the gap of the calender, a machine comprising a number of heatable parallel cylindrical rollers which rotate in opposite directions and spread out the polymer and stretch it to the required thickness. The last roller smooths the film thus produced. If the film is required to have a textured surface, the final roller is provided with an appropriate embossing pattern. Alternatively, the film may be reheated and then passed through an embossing calender. The calender is followed by one or more cooling drums. Finally, the finished film is reeled up.

Films may be printable to provide the consumer with product information, instructions, and/or to provide a pleasing appearance to the package prepared from the film.

The films may be further modified to provide valuable attributes to the films and to the packaging products produced therefrom. For example, the films may be treated by radiation such as E-beam treatment, X-ray treatment, gamma ray treatment, β- ray treatment, and the like. E-beam treatment of the films of the present invention with an intensity in the range of about 2 MRd (megarad) to about 20 MRd, or about 2.5 MRd to about 15 MRd, may provide an increase in the softening point of the film (Vicat Softening Point) of about 20° C. to about 50° C.

The films may be irradiated to the point of forming crosslinked polymer networks in one or more of the polymeric film layers. The treatment includes irradiation of the film in a manner similar to above, but typically at higher doses similar to that disclosed in, for example, U.S. Pat. No. 4,064,296. A typical dosage of high-energy electrons is in the range of up to about 160 MRd to about 1,666 MRd, up to about 440 MRd to about 1,390 MRd, or in the range of up to about 710 MRd to about 1,110 MRd. The irradiation may be carried out by an electron accelerator and the dosage amount is determined by standard dosimetry methods. Such crosslinked films can be useful for cook-in food packaging.

One or both outer surfaces of the polymeric film may be treated to enhance adhesion with, for example, the food to be packaged or to other substrates during lamination. This treatment may take any form known within the art, including flame treatments such as disclosed in US 2,632,921, US 2,648,097, US 2,683,894, and US 2,704,382, plasma treatments such as disclosed within U.S. Pat. No. 4,732,814, electron beam treatments, oxidation treatments, corona discharge treatments, chemical treatments, chromic acid treatments, hot air treatments, ozone treatments, ultraviolet light treatments, sand blast treatments, solvent treatments, and the like and combinations of two or more thereof. For example, corona discharge treatments as disclosed in, e.g., US 4,120,716 and US 4,879,430, refer to subjecting the film's surfaces to a corona discharge (such as the ionization of a gas such as air in close proximity to a film surface, the ionization initiated by a high voltage passed though a nearby electrode) which may cause oxidation and other changes to the film's surfaces which may enhance, for example, adhesion to the food to be packaged therein.

A film can be stress-relieved and shrink-stable under the coating and lamination processes. The polymeric film can be heat stabilized to provide low shrinkage characteristics when subjected to elevated temperatures, (i.e. less than 2% shrinkage in both directions after 30 minutes at 150° C.). Alternatively, a film may be heat-shrinkable. Generally, heat-shrinkable packaging films are oriented, more typically, biaxially oriented.

Shrinkage can be controlled by holding the film in a stretched position and heating for a few seconds before quenching. This heat stabilizes the oriented film, which then may be forced to shrink only at temperatures above the heat stabilization temperature. Further, the film may also be subjected to rolling, calendering, coating, embossing, printing, or any other typical finishing operations known within the art.

The above process conditions and parameters for film making by any method in the art are easily determined by a skilled artisan.

The multilayer packaging films and sheets may include other layers which provide one or more attributes, such as barrier properties, structural properties, puncture resistance, adhesive properties, such as tie layers, color properties, aesthetic properties, cook-in properties, and the like. The other layers may be formed from the materials as described above for the blend components or may be any known within the art.

For example, a layer can be attached within the multilayer film by an intermediate adhesive or tie layer using an adhesive or tie layer. An adhesive includes, e.g., the compositions disclosed herein, ionomers, polyurethanes, epoxies, polyesters, acrylics, anhydride modified polyolefin, or combinations of two or more thereof.

For example, a thermoformable packaging film useful, for example, for food or medical packaging, may take the form of a three layer film with the outer layers being comprised of ethylene-co-vinyl acetate copolymers and the inner layer being comprised of the ionomer of the present invention or of the ionomer blends of the present invention. Such thermoformable packages have abrasion resistance and puncture resistance. The films and multilayer films disclosed here can provide enhanced processability through, for example, thermoforming, than found for other commonly utilized ionomeric materials and blends.

The barrier layer can be between about 2.5μ (0.1 mils) and about 12.5μ (0.5 mils) by incorporating barrier materials such as polyamides, vinylidene chloride copolymers, ethylene vinyl alcohol copolymers, or combinations of two or more thereof and, optionally, other materials, such as the ionomers to provide further desirable attributes.

The invention also includes an article or package comprising or produced from a film or sheet or a multilayer film or multilayer sheet disclosed herein. The article can include bag, chub film, shrink bag, pouch, or formed cavity or tray, vacuum packs, or lid. The package can include food packaging for enhanced oil and fat penetration resistance, cook-in food, meat adhesion, meat casing, or combinations of two or more hereof. The package can be used to package foods, condoms, alcohol toweletes, or combinations of two or more thereof. The food includes smoked food, whole muscle meat, processed meat, marinated meat, frankfurters, ground beef, poultry, ham, bacon, fish, seafood, salty snacks, biscuits, crackers, cookies, block cheese, shredded cheese, dairy foods (yogurt, etc), powdered mixes, spices, juices, condiments, salad dressing, or combinations of two or more thereof.

The films and multilayer films disclosed here can provide enhanced oil and fat penetration resistance than found for other commonly utilized ionomeric materials and blends and can be desirable for fatty food packaging materials, such as meat packaging materials.

The compositions disclosed herein can be useful for cook-in food packaging. “Cook-in”, means that the packaging material is structurally capable of withstanding exposure to long and slow cooking conditions, such as about 57° C. to about 121° C. or about 57° C. to about 95° C. for about 2 to about 12 hours while containing the food product for in situ cooking such as submersion in water at 70-80° C. for 4-6 hours, or cooking in steam. Cook-in packaged meats, for example, are essentially prepackaged, precooked meats which are directly transferred to the retailer or the consumer in this form. These types of meats may be consumed with or without warming. Cook-in packaging materials maintain seal integrity and in the case of multilayer films, are delamination resistant. Cook-in films are preferably heat shrinkable under cook-in conditions so as to form a tightly fitting package. They also can adhere to the cooked meats, thereby preventing cook-out. This can be attained by positioning a layer of the ionomeric materials or ionomeric blend materials of the present invention in direct contact with the meat since these materials have excellent adhesion to meat. The adhesion of the packaging film to the meat is frequently needed to avoid “purge”, (cook-out, i.e.; the collection of juices between the outer surface of the food product and the meat-contact surface of the film), which can occur during the cooking of the meat packaged in the film if the film does not adhere well to the meat.

The films may further be subject to post formation processes to enhance even further the meat adhesion, such as through corona treatment (also known as corona discharge treatment).

Meat casing packaging is generally wound up as a flattened, seamless, tubular film. The cook-in tubes may then be formed into bags by end seals, generally made by clips or by transverse heat sealing across the width of the flattened tubing followed by severing the tubing so that the transverse seal forms the bag bottom. Alternatively side-seal bags, (often referred to as “backseamed casings”), may be formed in which the transverse seals form the bag sides and one edge of the tubing forms the bag bottom, or the tubular stock may be slit into sheet stock for further forming into back-seamed tubes by forming an overlap or fin-type seal. The packaging films may be sealed by any method known within the art, e.g., through heat sealing such as with hot air and/or heated bar or wire, ultrasonic sealing, radio frequency sealing, and the use of clips, such as a shirred clip.

Meat casing packaging films can incorporate barrier layers, be irradiated to increase their resistance to cook-in conditions, and be heat shrinkable through, for example, biaxially-orientation.

To prepare the meat product package, the casings (cook-in tubes) are used by placing the uncooked meat in the tube and sealing the open portion of the packaging, for example through clipping or heat sealing. The packaged meat product is then ready for cooking, as described above. The meat product can comprise, for example, at least one member selected from the group consisting of poultry, chicken, turkey, ham, pork, beef, lamb, fish, sausage, liver sausage, bologna, mortadella, braunschweiger, goat, horse, and the like. The casings are not only useful for meat products, such as sausages, but also for other packaging, such as animal food, cheese, pastry and other pasty or liquid foodstuffs. The casings can be processed for the consumer through known techniques, such as printing, ring-forming, and shirring.

The films can also be suitable as chub films, generally utilized for the packaging of ground beef, sausages, and other comminuted food substances. Chub films are typically used in a vertical form fill seal (VFFS) process. In the VFFS process, a flat film of roll stock is first horizontally pulled through a forming shoulder and then vertically passed through a forming column which is connected to the forming shoulder. While the film is moving along the forming column, a tube is simultaneously formed with a longitudinal lap seal by a vertical seal bar, and, at the same time, the bottom end of the tube is closed with a wire clip. Once the tube is formed, a product with a certain weight, such as ground beef, is vertically filled and then the top end of the tube is closed by a wire clip. Finally, the package is cut apart from the following tube and transported to the packers. Chub packages are generally produced at a meat processing plant operated either by meat companies or supermarket chain stores for both retailer and institutional use. Chub packages are commonly treated through a chiller at about -10 to -20° C. to form crust frozen packages for longer shelf life. Package sizes usually can vary depending upon the purpose of the distribution. Films utilized for chub packages could be clear films, pigmented films, or printed films.

Packaged foods disclosed herein may be smoked through common art processes. Smoking may include cold smoking, at temperatures up to about 25° C., warm smoking, at temperatures between about 25 and about 50° C., and hot smoking, at temperatures above about 50° C. The smoke, owing to its aldehyde, phenolic and acid-containing constituents, also has a preservative, antioxidant, and solidifying action.

Packaged films may be treated with flavorants, curing agents, colorants, perfumes, and the like. The films and multilayer films disclosed herein can provide enhanced resistance to commonly used flavorants, curing agents, colorants, perfumes, and the like, than found for other commonly utilized ionomeric materials and blends and is desirable for food packaging materials in which such additives are used, such as liquid smoke. Liquid smoke is a solution of natural wood smoke flavors prepared by burning a wood (e.g., a hickory or a maple) and capturing the natural smoke flavors in a liquid medium (e.g., water) to impart a particularly pleasing smoked flavor, aroma and color to foods. See e.g., U.S. Pat. No. 3,106,473.

Other suitable flavorants and/or perfumes include aroma extracts of garlic, caraway seed, pepper, red pepper, a grill flavor and the like, or combinations of two or more thereof.

Colorants may include, annatto extract, erythrosine, amaranth, brown FK, tartrazine, black BN, caramel, and the like, or combinations of two or more thereof.

Films also may be useful for vacuum skin packaging, which is a well known process whereby a thermoplastic packaging material is used to enclose a product generally, but not necessarily a food product, such as meat, processed meat, fish and the like. Because it is well known, the description of which is omitted for the interest of brevity.

The films of the present invention are further useful for vacuum packaging applications, ATMOS packaging applications which fill the package with, for example, a gaseous mixture of nitrogen, carbon dioxide, and oxygen, (atmosphere like), and the like. Other utilities include packaging applications (food applications, such as processed meat, snack foods, powdered drinks, condiments and fresh produce) and for non-food applications (e.g., medical packaging).

### EXAMPLES

### Comparative Example CE1

Blown film of an ethylene-co-methacrylic acid copolymer with 81 weight % ethylene and 19 weight % methacrylic acid (37% neutralized with sodium ions); 2 mils (50μ) thick) was soaked in liquid smoke, (Haddon House® liquid smoke from the Haddon House Food Products Company), which had a pH of about 2.5. After three days, the films had whitened.

### Example 1

Blown film of an ethylene-co-methacrylic acid copolymer with 81 weight % ethylene and 19 weight % methacrylic acid (39% neutralized with magnesium ions which was 2 mils (50μ) thick) was prepared as disclosed in Example CE 1. After six days of being soaked in the liquid smoke, no change in the films was observed.

This example demonstrates that the magnesium-neutralized ionomers resisted to common flavorants used in packaging applications, when compared to the sodium-neutralized ionomers.

### Comparative Example CE 2

A film of an ethylene-co-methacrylic acid copolymer with 81 weight % ethylene and 19 weight % methacrylic acid which was 36% neutralized with zinc ions prepared as disclosed in Example CE1, 2.2 mils (56μ) thick, was subjected to a grease penetration test, (test protocol F119), which involved measuring the time for soybean oil to penetrate the film at 60° C. Results observed were 144 hours, 151 hours and 247 hours.

### Example 2

A film of an ethylene-co-methacrylic acid copolymer with 81 weight % ethylene and 19 weight % methacrylic acid which was 39% neutralized with magnesium ions prepared as disclosed in Example CE2, 2.65 mils (67μ) thick, was subjected to the grease penetration test. Results observed were 375 hours and 471 hours.

This example demonstrates that the magnesium neutralized ionomers resisted to grease/oil (a characteristics desired for meat packaging applications) when compared to zinc-neutralized ionomers.

### Examples 3-8

Three-layer blown films, as shown in Table 1, are prepared on a blown film line using a 5 cm (2 inch) diameter Brampton die. The processing temperature for the 3-layer blown film line is 210° C.

TABLE 1

| Example | Layers* | | |
|---|---|---|---|
| 3 | Ionomer Resin 1 | mPE 1 | Ionomer Resin 1 |
| 4 | Ionomer Resin 1 | LDPE 1 | Ionomer Resin 1 |
| 5 | Ionomer Resin 1 | Blend 1 | Ionomer Resin 1 |
| 6 | Ionomer Resin 1 | Blend 1 | Ionomer Blend 1 |
| 7 | Ionomer Resin 1 | Blend 1 | Ionomer Blend 2 |
| 8 | Ionomer Blend 1 | Blend 1 | Ionomer Blend 1 |
| *Each ionomer resin or blend layer is 30μ thick, the middle layer (mPE, LDPE, and Blend) is 40μ thick. Ionomer Resin 1 is an ethylene-co-methacrylic acid copolymer with 81 weight % ethylene and 19 weight % methacrylic acid which is 40% neutralized with magnesium ions; mPE 1 is a metallocene polyethylene (octene mPE) with a density of 0.879 g/cc (available from the Dow Chemical Company); LDPE 1 is a low density polyethylene with a density of 0.923 g/cc; Ionomer Blend 1 is a | | | |
| # blend containing 70 weight % of the Ionomer resin and 30 weight % of the mPE 1, Ionomer Blend 2 is a blend containing 80 weight % of the Ionomer resin and 20 weight % of the LDPE 1; and Blend 1 is a blend containing 80 weight % of mPE 1 and 20 weight % of LDPE 1. | | | |

### Examples 9-11

Three-layer thermoformable films, shown in Table 2, are formed with an air blown film line using standard equipment. The production conditions are as follows,
Total film gauge, 100μ
Die set temperature, 210° C.
Blow up ratio, 2:1
Die gap, 1.86 mm
Haul off speed—19.8 m/min.

Frost line 31,28 cm (the point at which the molten film becomes solid).

TABLE 2**

| Example | Thickness of Layers | | |
|---|---|---|---|
| 9 | EVA 1 (25μ) | Ionomer Resin 2 (50μ) | EVA 1 (25μ) |
| 10 | EVA 1 (15μ) | Ionomer Blend 3 (70μ) | EVA 1 (15μ) |
| 11 | EVA 1 (20μ) | Ionomer Blend 4 (60μ) | EVA 1 (20μ) |
| **The three-layer film constructions include EVA 1 (4.5 weight % vinyl acetate and 95.5 weight % ethylene); Ionomer Resin 2 (an ethylene-co-methacrylic acid copolymer with 85 weight % ethylene and 15 weight % methacrylic acid which is 50% neutralized with magnesium ions); Ionomer Blend 3 (a blend containing 70 weight % of the Ionomer resin and 30 weight % of an ethylene-co-methyl acrylate copolymer with 24 weight % methyl (a blend containing 80 weight % of the Ionomer resin and 20 | | | |
| # weight % of a metallocene catalyzed linear low density polyethylene with a density of 0.917 g/cc and a molecular weight distribution Mw/Mn of 2.3). Each film is thermoformed using conventional thermoforming equipment to a depth of about 3.2 cm in a cavity 20.3 cm long by 12.7 cm wide. | | | |

### Examples 12-15

Shown in Table 3 are flexible, three-layer films of about 8.5 inches flat width, prepared by coextrusion. The outer layer for all Examples is composed of a blend of 75 weight % of an ultra low density polyethylene with a density of 0.912 g/cc, (Attane® 4001, Dow Chemical Company), and 25 weight % of an ethylene vinyl acetate copolymer, (Elvax® 3135X, DuPont), with a thickness of about 20μ (0.8 mils). The middle, barrier layer is composed of VCI 1, a blend of a vinylidene chloride-co-vinyl chloride copolymer, incorporating 7.2 weight % vinyl chloride, and of a vinylidene chloride-co-methyl acrylate copolymer, incorporating 6 weight % methyl acrylate. The inner layer is composed of Ionomer Resin 3, which is an ethylene-co-methacrylic acid copolymer with 79 weight percent ethylene and 21 weight percent methacrylic acid which is 30 percent neutralized with magnesium ions (what is the composition of Ionomer Resin 3?), composed of Ionomer Blend 5, a blend of 75 weight % Ionomer Resin 3 with 25 weight % of EVA 2, which is an ethylene-co-vinyl acetate copolymer with 10 weight % vinyl acetate and 90 weight % ethylene, (commercially available from the Union Carbide Company), composed of Ionomer Blend 6, a blend of 50 weight % of Ionomer Resin 3 with 50 weight % of EVA 2, or composed of Ionomer Blend 7, a blend of 25 weight % Ionomer Resin 3 with 75 weight % of EVA 2.

TABLE 3

Thickness of Layers***

| Example | Barrier Layer | Inner Layer |
|---|---|---|
| 12 | VCl 1 | Ionomer Resin 3 |
| 13 | VCl 1 | Ionomer Blend 5 |
| 14 | VCl 1 | Ionomer Blend 6 |
| 15 | VCl 1 | Ionomer Blend 7 |

***All barrier layers are 8 μ thick and inner layers were 43μ.

For all Examples, OxyDry® C-5 corn starch powder, (from the OxyDry Corporation), is applied at the level of 12 g/1000 ft² film surface area to the hot inner layer as a substantially uniform dispersion of particles. All Examples are biaxially-oriented and irradiated to a dosage of about 4 MRd. All tube Examples are then clipped at one end and stuffed with ground ham and shank meat, (primarily composed of particles of about 5/64 inch size having a protein content of about 11-12 weight % and a fat content of about 21-22 weight %) at a stuff temperature of about 47° F. Five 10-pound (precooking weight) product meat packages are made from packaging film of each Example. The tubes are stuffed on a Tipper Tie® RS 4201 type commercial stuffing machine to a circumference equal to twice the tube flat width of each Example. The stuffed tube lengths are about 12.5 to about 13.0 inches and placed in molds 12½ inches long, 4¾ inches wide and 5½ inches deep. A 160° F. water bath is used to cook the hams for about 4 to 5 hours to an internal temperature of about 152° F. The cooked hams are cooled to an internal temperature of about 70° F. and then separated from the molds.

### Example 16

A blend incorporating 75 weight % Ultramid® A5 (from the BASF Corporation, believed to be Nylon 6,6), 17.5 weight % Grilon® F 40 (from EMS Chemie, believed to be Nylon 6), and 7.5 weight % Ionomer Resin 3 is fed to an extruder and is melt compounded at temperatures ranging from about 210° C. to about 300° C. Single layer tubular casings 90μ thick are formed from the blend.

### Example 17

Single layer tubular casings are produced as described in Example 16 and additionally biaxially oriented.

### Example 18

A blend incorporating 66 weight % Ultramid® A5, 11 weight % Grilon® F 40, 10 weight % Ionomer Resin 3, 9 weight % glass microbeads, and 4 weight % Quartz flour is fed to an extruder and was melt compounded at temperatures ranging from about 210° C. to about 300° C. Single layer tubular casings 60μ thick are formed from the blend through commonly known blown film processes.

### Example 19

Single layer tubular casings are produced as described in Example 18 and additionally biaxially oriented.

### Example 20

A blend incorporating 75 weight % Ultramid® A5, 11 weight % Pebax MH 1657 SA (from Elf Atochem, believed to be a Nylon 6/poly(ethylene glycol) block copolymer), 10 weight % Ionomer Resin 1, and 4 weight % glycerol is fed to an extruder and was melt compounded as in Example 18. Single layer tubular casings 80μ thick are formed.

### Example 21

Single layer tubular casings are produced as described in Example 20 and additionally biaxially oriented.

### Example 22

A blend incorporating 72 weight % Ultramid® A5, 10 weight % Pebax MH 1657 SA, 10 weight % Ionomer Resin 1, 4 weight % cellulose powder, and 4 weight % glycerol is fed to an extruder and melt compounded as in Example 18. Single layer tubular casings 70μ thick are formed from the blend.

### Example 23

Single layer tubular casings are produced as described in Example 22 and additionally biaxially oriented.

### Examples 24-25

Seven layer tubular film casings with the layer compositions noted in Table 4 are prepared by blown film processes and biaxially stretched to provide tubular films with a diameter of 60 mm and the layer thicknesses noted. Ionomer Blend 8 is a blend of 80 weight % Durethane® B 40 F (from the Bayer AG Corporation, believed to be nylon 6) with 20 weight % of Ionomer Resin 1. Blend 2 is a blend of 99 weight % Dowlex® 2045 E, (from Dow Chemical Company, believed to be LLDPE), with 1 weight % titanium dioxide. PA 6/69 is Grilon® CF62BS (from the EMS Chemie, believed to be a nylon 6/nylon 69 copolyamide). Ionomer Blend 9 is a blend of 90 weight % Eval® LC F 101 BZ (from the Kuraray Company, believed to be an EVOH), and 10 weight % of Ionomer Resin 2. Blend 3 is a blend of 99 weight % Durethan® B 40 F with 1 weight % of a silica antiblocking agent. Ionomer Blend 10 is a blend of 89 weight % Durethan® B 40 F, 10 weight % of Ionomer Resin 3, and 1 weight % of a silica antiblocking agent. TL1 is Admer L 2100 (from the Mitsui Chemical Company, believed to be a modified polyethylene). Ionomer Blend 11 is a blend of 70 weight % of Durethan® B 40 F, 20 weight % of Nylon MX® 6007 (from the Mitsubishi Gas Chemical Company, believed to be poly(m-xylyleneadipamide), (MXD6)), and 10 weight % of Ionomer Resin 1.

TABLE 4

Thickness of Layers
Example

| | 24 | 25 |
|---|---|---|
| Layer A (inner) | Ionomer Blend 8 (5μ) | Ionomer Blend 10 (5μ) |
| Layer B | Ionomer Resin 3 (2μ) | TL 1 (2μ) |
| Layer C | Blend2 (15μ) | Ionomer Resin 2 (15μ) |
| Layer D | Ionomer Resin 3 (2μ) | TL 1 (2μ) |
| Layer E | PA 6/69 (5μ) | Ionomer Blend 11 (5μ) |
| Layer F | Ionomer Blend 9 (4μ) | EVOH (4μ) |
| Layer G (outer) | Blend 3 (15μ) | Blend 3 (15μ) |

The tubular casings are heat sealed at one end, stored for 20 minutes at 20° C., filled with a liver sausage filling, heat sealed at the open (filling) end and then cooked for one hour at 80° C.

### Example 26

An eight-layer multilayer thermoformable packaging films is produced by blown film process with a total film thickness of between about 50 to 101μ (about 2 to about 4 mils). Layer 1, the innermost film layer in direct contact with the food to be packaged, is Ionomer Resin 2 with a thickness of about 8% of the total multilayer film thickness; Layer 2 is a blend of 55 weight % ECD® 301 (produced by the Exxon Chemical Company, believed to be a homogeneous ethylene/α-olefin copolymer with a density of 0.915 g/cc), 35 weight % of Tafmer® PO 480, (produced by Mitsui Petrochemicals, believed to be a homogeneous ethylene/α-olefin plastomer with a density of 0.87 g/cc), and 10 weight % LD® 200.48, (produced by Exxon Chemical Company, believed to be LDPE with a density 0.923) with a thickness of about 20% of the total multilayer film thickness; Layer 3 is Ionomer Resin 3 with a thickness of about 11% of the total multilayer film thickness; Layer 4 is a blend of 75 weight % Ultramid® B35, (from the BASF Corporation, believed to be nylon 6), 15 weight % Selar® PA, (DuPont), and 10 weight % Ionomer Resin 2 with a thickness of about 6% of the total multilayer film thickness; Layer 5 is Ionomer Blend 9 disclosed above, with a thickness of about 6% of the total multilayer film thickness; Layer 6 is identical to Layer 4 with a thickness of about 6% of the total multilayer film thickness; Layer 7 is Bynel® 30E671 (from the DuPont Company), with a thickness of about 35% of the total multilayer film thickness; and Layer 8 is a blend of 99 weight % Ultramid® B35 with 1 weight % of a silica antiblocking agent with a thickness of about 8% of the total multilayer film thickness.

Seven conventional single-screw extruders are employed to melt and pump the various resins to a distribution block or adapter and then to an annular coextrusion die. Ionomer Blend 9 of Layer 5 is processed at temperatures of from about 350° F. to about 450° F. Ionomer Resin 2 of Layer 1, the polyolefin blend of Layer 2, and the Ionomer Resin 3 of Layer 3, are processed at temperatures of about 400° F. to about 500° F. The Bynel® 30E671 of Layer 7 is processed at temperatures of about 420° F. to about 460° F. The blends of Layer 4, Layer 6, and Layer 8 are processed at temperatures of from about 450° F. to about 550° F. The melt distribution system and die are designed to produce uniform thickness distribution around the circumference of the die for all eight layers.

The flattened tape is passed though pinch rollers, heated in a hot water bath or by a hot air oven, and expanded by inflating the tube with high pressure air in what is commonly referred to within the art as the “trapped bubble technique”. In this manner, a thermoplastic film of the desired thickness was produced. The oriented film, in the form of a lay flat tubing, is then cut lengthwise, (i.e., along both edge creases), to form two separate film sheets, each of which is wound up onto two substantially identical, but separate, rolls. Thereafter, each of the rolls is resized on a slitter to produce a width and diameter suitable for a horizontal packaging machine, such as, for example, a Tiromat® thermoforming packaging machine, a Multivac® thermoforming packaging machine, a Pioneer® thermoforming packaging machine, or a Mahaffey Harder® thermoforming packaging machine. The film is primarily utilized as the forming film of the machine, but it could also be used as a non-forming film.

The film is suitable for the packaging of food products such as fresh and processed poultry, fresh and processed red meat, fresh and processed fish, fresh and processed pork, cheese, hot dogs, bacon, summer sausage, block cheese, and cheese sticks and the like. The foods packaged in the film could be precooked, marinated, preseasoned, breaded, and the like.

The film is suitable for use in forming and/or non-forming films for cook-in applications. The sealant (inner) layer may be further corona or irradiation treated to improve even greater the meat adhesion to the protein extracted meat emulsion mixture typical of cooled ham, ham emulsion, turkey breast, turkey emulsion, chicken emulsion, and the respective products of cooked ham, pressed ham, turkey roll, chicken roll, luncheon meats and the like and other processed meat products.

Alternatively, the tubular film may be utilized directly without slitting to form casings for, for example, processed meat products, such as cooked ham, turkey rolls, sausage, bologna, and the like. The shirred casing strand was inserted onto a stuffing horn, with the sealed or clipped end at the exit orifice of the stuffing horn. The casing is fed through a brake hole through which the meat mixture is then pumped. This mechanism allows the meat mixture to be pumped into the casing at a controlled pressure, (i.e.; the hydrostatic pressure developed by the elastic memory of the stretched casing).

### Example 27

Ionomer Blend 12, which consists of 95 weight % Eval® LC F 101 BZ (from the Kuraray Company, believed to be an EVOH), and 5 weight % of Ionomer Resin 3 is extrusion compounded on a 30-mm twin-screw extruder equipped with kneading discs with a L/D of 30 with a feed zone barrel temperature of 190 C and a mixing barrel and die plate temperature of 210° C. at a screw speed of 610 rpm and is chopped into pellets.

A five-layer, thermoformable film with a total thickness of 130μ is prepared through T-die coextrusion. The multilayer film has the construction of an Ultramid® B35 layer/a Bynel® 30E671 layer/an Ionomer Blend 12 layer/a second Bynel® CXA 3095 layer/a LLDPE layer with the respective layer thicknesses of 20μ/5μ/20μ/5μ/80μ.

The multilayer film is thermoformed into a container on a R530 thermoforming machine (from the Multiback Company), with a temperature of the heating plate of 100° C., a heating time of 1.5 seconds, and a film temperature of about 85° C., with a rectangular mold with the dimensions of 130 mm long, 110 mm wide, and 50 mm deep.

The containers were suitable for, for example, the packaging of custards, puddings, custard puddings, jellies, jellos, yogurts, and the like.

### Example 28

Example 27 is repeated except Ionomer Blend 12 is replaced with Ionomer Blend 9.

### Example 29

Example 27 is repeated except Ionomer Blend 12 is replaced with Ionomer Blend 13, which is a blend of 85 weight % Eval® LC F 101 BZ, (from the Kuraray Company, an EVOH), and 15 weight % of Ionomer Resin 3.

### Example 30

Example 27 is repeated except Ionomer Blend 12 is replaced with Ionomer Blend 14, which is a blend of 80 weight % Eval® LC F 101 BZ, and 20 weight % of Ionomer Resin 3.

### Example 31

Example 27 is repeated except Ionomer Blend 12 is replaced with Ionomer Blend 15, which is a blend of 70 weight % Eval® LC F 101 BZ, and 30 weight % of Ionomer Resin 3.

### Example 32

A seven-layer coextruded blown film is made with the construction: nylon/tie/nylon/EVOH/nylon/tie/ionomer. The nylon layers comprise a blend of 80% nylon 6 and 20% EMS Grivory G21, an amorphous nylon. The EVOH is EVALCA LCH101A, a 38 mol % ethylene grade. The tie resins are anhydride modified EVA or LLDPE such as Bynel® 4157. The ionomer was Ionomer Resin 1. Total thickness is 6 mils with layer thickness 10%/20%/10%/10%/10%/10%/30%. The film is useful as a forming web for processed meat packaging such as frankfurters, luncheon meats, bacon and sausage.

### Example 33

Example 32 is repeated with Ionomer Resin 1 is replaced with Ionomer Resin 2.

### Example 34

Example 32 is repeated with an ethylene-co-methacrylic acid copolymer with 90 weight % ethylene and 10 weight % methacrylic acid which is 55% neutralized with magnesium ions.

### Example 35

A three layer blown film is made with the structure: EVA/ionomer/EVA. The EVA contains 4.5 wt % VA. The ionomer is Ionomer Resin 2. Total thickness is 6 mils and layer thickness 30%/40%/30%. The film is useful as a forming web for medical device packaging.

1. A composition comprising or produced from an olefin polymer and a polyamide, a barrier resin, a polyolefin, a vinyl ester copolymer, or combinations of two or more thereof wherein
the olefin copolymer is magnesium ion-neutralized and comprises repeat units derived from an α-olefin and a comonomer including one or more α-, β-ethylenically unsaturated carboxylic acids;
the olefin copolymer comprises from about 1 to about 30, or about 12 to about 30, or about 18 to about 25, weight % of the comonomer based on the total weight of the copolymer;
the barrier resin includes polyacrylonitrile resin, polyvinylidene chloride resin, ethylene vinyl alcohol copolymer, polyalkylene carbonate resin, an oxygen barrier resin, or combinations of two or more thereof;
the vinyl ester copolymer comprises repeat units derived from an α-olefin and a vinyl ester; and
about 5 to about 90, about 10 to about 75, or about 20 to about 60, % of the carboxylic acid in the olefin copolymer is neutralized with a magnesium ion.

2. The composition of claim 1 wherein the composition comprises from about 1 to about 99, about 50 to about 99, or about 80 to about 98, weight % of polyamide.

3. The composition of claim 1 wherein the composition comprises from about 1 to about 99, about 60 to about 99, about 70 to about 97, or about 80 to about 95, weight % of the barrier resin.

4. The composition of claim 2 wherein the composition comprises from about 1 to about 99, about 60 to about 99, about 70 to about 97, or about 80 to about 95, weight % of the barrier resin.

5. The composition of claim 1 wherein the composition comprises from about 1 to about 99, about 10 to about 50, about 10 to about 30, or about 10 to about 25, weight % of the polyolefin.

6. The composition of claim 2 wherein the composition comprises from about 1 to about 99, about 10 to about 50, about 10 to about 30, or about 10 to about 25, weight % of the polyolefin.

7. The composition of claim 3 wherein the composition comprises from about 1 to about 99, about 10 to about 50, about 10 to about 30, or about 10 to about 25, weight % of the polyolefin.

8. The composition of claim 4 wherein the composition comprises from about 1 to about 99, about 10 to about 50, about 10 to about 30, or about 10 to about 25, weight % of the polyolefin.

9. The composition of claim 1 wherein the composition comprises from about 1 to about 99, about 1 to about 50, about 1 to about 30, or about 5 to about 25 weight % of the vinyl ester copolymer.

10. The composition of claim 2 wherein the composition comprises from about 1 to about 99, about 1 to about 50, about 1 to about 30, or about 5 to about 25 weight % of the vinyl ester copolymer.

11. The composition of claim 3 wherein the composition comprises from about 1 to about 99, about 1 to about 50, about 1 to about 30, or about 5 to about 25 weight % of the vinyl ester copolymer.

12. The composition of claim 4 wherein the composition comprises from about 1 to about 99, about 1 to about 50, about 1 to about 30, or about 5 to about 25 weight % of the vinyl ester copolymer.

13. The composition of claim 5 wherein the composition comprises from about 1 to about 99, about 1 to about 50, about 1 to about 30, or about 5 to about 25 weight % of the vinyl ester copolymer.

14. The composition of claim 6 wherein the composition comprises from about 1 to about 99, about 1 to about 50, about 1 to about 30, or about 5 to about 25 weight % of the vinyl ester copolymer.

15. The composition of claim 7 wherein the composition comprises from about 1 to about 99, about 1 to about 50, about 1 to about 30, or about 5 to about 25 weight % of the vinyl ester copolymer.

16. The composition of claim 8 wherein the composition comprises from about 1 to about 99, about 1 to about 50, about 1 to about 30, or about 5 to about 25 weight % of the vinyl ester copolymer.

17. A film or sheet comprising at least one layer that comprises or produced from an olefin copolymer, a composition, or combinations thereof wherein the composition comprises the olefin copolymer and a polyamide, a barrier resin, a polyolefin, a vinyl ester copolymer, a carboxylate ester copolymer, or combinations of two or more thereof wherein the olefin copolymer, polyamide, barrier resin, polyolefin, vinyl ester copolymer are each as recited in claim 1, 2, 3, 4, 5, 6, 7, 8, 9, 10, 11, 12, 13, 14, 15, or 16 and the carboxylate copolymer comprises repeat units derived from an α-olefins and an α-, β-ethylenically unsaturated carboxylate ester, or combinations of two or more thereof and is optionally present in the composition from about 1 to about 99, about 1 to about 30, or about 5 to about 25 weight %.

18. The film or sheet of claim 17 being treated by or with plasma treatment, radiation, oxidation treatment, corona discharge treatment, chemical treatment, chromic acid treatment, hot air treatment, ozone treatment, ultraviolet light treatment, sand blast treatment, solvent treatment, flavorant, curing agent, colorant, perfume, or combinations of two or more thereof optionally including electron beam treatment, X-ray treatment, gamma ray treatment, β- ray treatment, or combinations of two or more thereof and optionally irradiation to forming crosslinked polymer networks in one or more layers.

19. A film or sheet comprising or produced from a least one layer of a copolymer comprising repeat units derived from ethylene and methacrylic acid wherein the methacrylic acid is neutralized with magnesium ions and the film or sheet is optionally a blown film.

20. An article or package comprising or produced from a multilayer film or multilayer sheet wherein
the multilayer film or multilayer sheet is as recited in claim 18;
the article includes bag, chub film, shrink bag, pouch, or formed cavity or tray, vacuum packs, or lid;
the package includes food packaging for enhanced oil and fat penetration resistance, cook-in food, meat adhesion, meat casing, or combinations of two or more hereof;
the package optionally having packaged therein foods, condoms, alcohol toweletes, or combinations of two or more thereof; and
the food includes smoked food, whole muscle meat, processed meat, marinated meat, frankfurters, ground beef, poultry, ham, bacon, fish, seafood, salty snacks, biscuits, crackers, cookies, block cheese, shredded cheese, dairy foods (yogurt, etc), powdered mixes, spices, juices, condiments, salad dressing, or combinations of two or more thereof.
